(19) United States
(12) Patent Application Publication
(10) Pub. No.: US 2006/0048627 A1
(43) Pub. Date: Mar. 9, 2006

(54) Tremolo device

(76) Inventor: David Eshleman, Dewey, IL (US)

Correspondence Address: Michael Berns;Maloney Parkinson & Berns, 135 West Main Street, Urbana, IL, 61801, US

(21) Appl. No.: 10/934,878

(22) Filed: Sep. 7, 2004

(51) Int. Cl. G10D 3/00

(52) U.S. Cl. 84/313

(57) ABSTRACT

By utilizing a lever arm parallel and adjacent to the strings, the present invention allows a guitar player to have an optional tremolo effect with less distraction, effort, and chance for mistakes. The invention uses a bar, below and generally parallel with the strings to provide the effect while the bar remains unobstructing and accessible.

### BACKGROUND OF THE INVENTION

The invention relates to a new and improved lever for a tremelo device for use in electric guitars. This particular lever is known as a tremelo bar, vibrato bar, or “whammy bar”.

Tremelo devices for stringed musical instruments are used to temporarily raise or lower the pitch of the tone by increasing or decreasing the tension of the strings.

As shown in FIG. 1, a guitar outfitted with a Tremolo Plate 1, located at the Bridge area on the body 2 of the guitar can be used to temporarily alter the pitch of the produced tones. The rocking motion of this plate by pushing or pulling of the tremolo bar 3 momentarily alters the string tension, thus changing the pitch of the produced tone.

Conventional tremolo bars sometimes present performance difficulties and limitations for the electric guitar player. When firmly mounted to an electric guitar, 4 conventional horizontally-extending tremolo bars can interfere with the strumming action of the guitarist by coming in contact with his/ or her hand. Thus many guitarists mount the previous styled tremolo bars loosely to the bridge plate which in turn allows the bar to swing freely, 5 downwardly, at 90-deg angle to the neck of the guitar. This can make “instinctive” and immediate accessibility a problem.

Another problem with aforementioned tremolo bars concern transporting the guitar in a guitar carrying case. In most instances, the tremolo bar must be removed from the guitar in order for the case to close properly. Potential pitfalls resulting from this could be (a) possibly misplacing or losing the tremolo bar due to continuous removal from the instrument, (b) possibly cross-threading the bar due to re-insertions back into the instrument or (c) wearing out the threads of tremolo plate or bar from prolonged insertion and removal of tremolo bar.

### SUMMARY OF THE INVENTION

This invention alleviates the problems addressed. By utilizing a lever arm parallel and adjacent to the strings, the tremolo effect can be achieved with less distraction, effort, and chance for mistakes.

### DESCRIPTION OF THE DRAWINGS

FIG. 1 is a side view cross-section of the prior art tremolo devices.

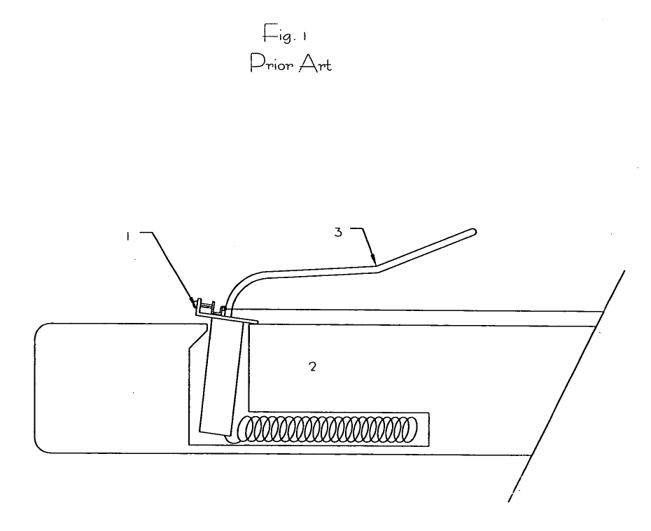

FIG. 2 is a front view of the prior art tremolo devices.

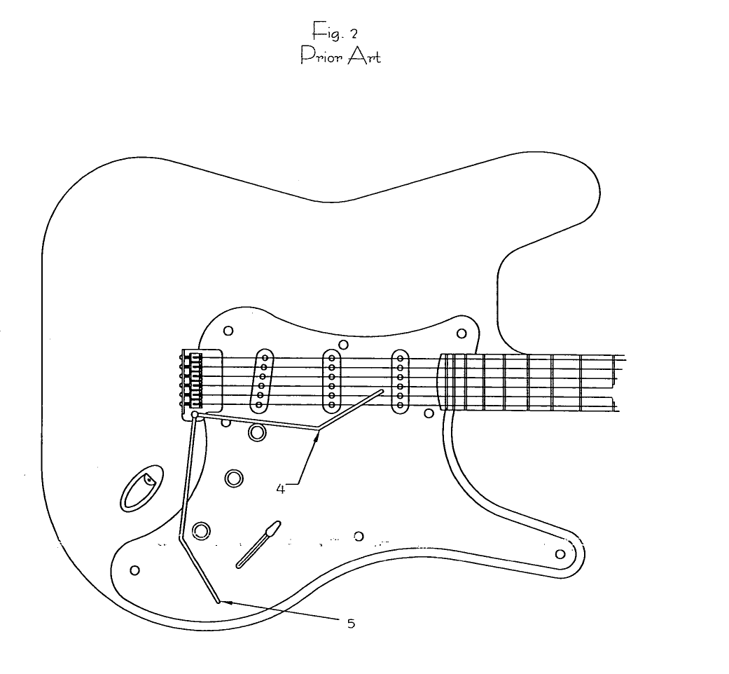

FIG. 3 is an exploded cross section view of an embodiment of the invention.

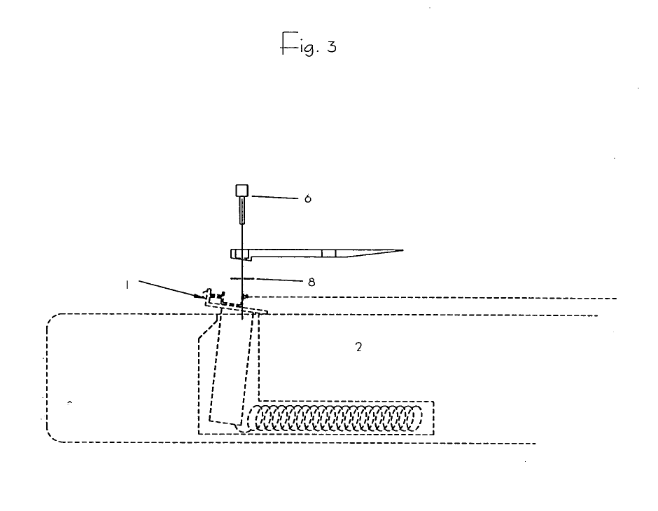

FIG. 4 is a side view cross-section of an embodiment of the invention.

FIG. 5 is a front view of an embodiment of the invention.

FIG. 6 is a front view of an embodiment of the invention.

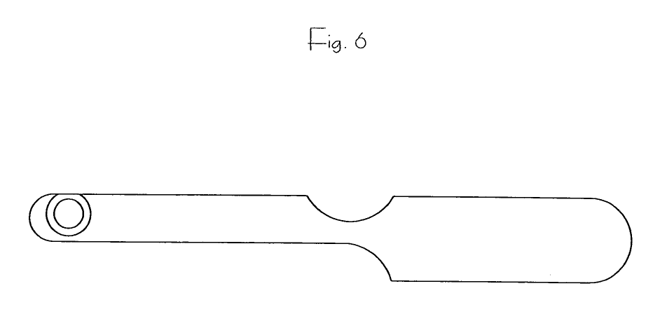

FIG. 7 is a side view of an embodiment of the invention.

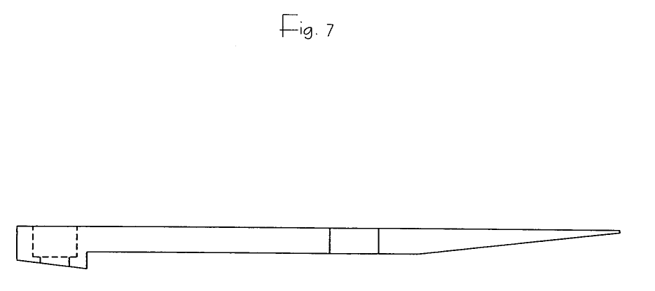

### DETAILED DESCRIPTION OF THE INVENTION

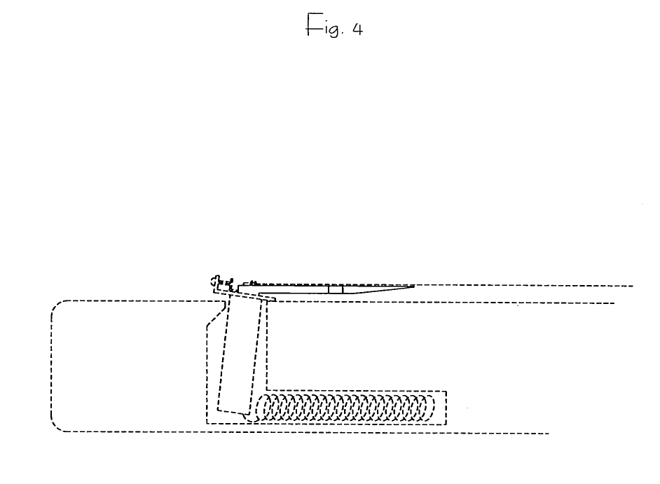

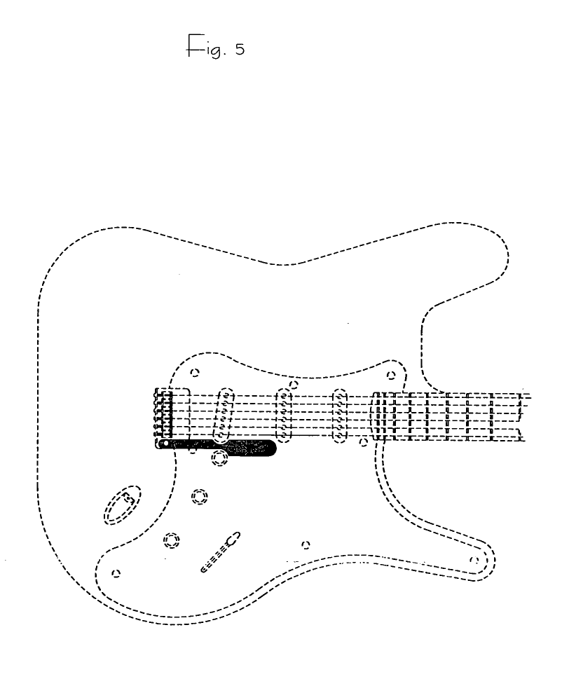

Referring to FIG. 5, the tremolo device of the present invention attaches firmly to the tremolo plate using a bolt 6 that tightens inside a routered cavity inside the guitar body. It should be attached so that it's parallel to the strings and is located between the high E “treble” string and the volume knob. As assembled in FIG. 5, once securely tightened, the top portion of the “Wonder Whammy” should be flush or slightly below the surface of the strings, seen in FIG. 4, enabling the guitarist to strum without his or her hand contacting the device. The angle of the tremolo plate in conjunction to the body varies from guitar to guitar, thus a small shim 8 might need to be placed either in front of or behind the bolt 6 that fastens the Wonder Whammy to the tremolo plate in order to achieve the correct height of the top of Wonder Whammy in reference to the strings. To use this device once it is secured, the guitarist merely needs to push down or pull up on the bar end opposite the bolted down end. This can be accomplished using any finger or thumb from the strum hand.

This device was designed for use on the Fender Stratocastor tremolo plate (see U.S. Pat. No. 2,741,146 to C. L. Fender) or similar tremolo plates from many guitar companies that have copied the Fender design.

The foregoing description of the preferred embodiments of the present invention. Various modifications and alternatives within the scope of the invention will be readily apparent to one of ordinary skill in the art. The invention is only limited by the claims appended hereto.

I claim:

1. A guitar tremolo device having a arm wherein the arm lies parallel and below the strings.

2. A guitar having a tremolo device wherein the tremolo device has an arm positioned in a fixed location parallel and below the strings.
